(19) United States
(12) Patent Application Publication
(10) Pub. No.: US 2013/0221909 A1
(43) Pub. Date: Aug. 29, 2013

(54) WIRELESS CHARGING DEVICE

(71) Applicant: Po-Sheng LEE, New Taipei City (TW)

(72) Inventor: Po-Sheng LEE, New Taipei City (TW)

(73) Assignee: CHICONY POWER TECHNOLOGY CO., LTD.

(21) Appl. No.: 13/482,136

(22) Filed: May 29, 2012

(30) Foreign Application Priority Data
Feb. 24, 2012 (TW) 101203422

(51) Int. Cl. H02J 7/00

(52) U.S. Cl. 320/108

(57) ABSTRACT

The wireless charging device is provided for coupling and charging a portable electronic device, and the portable electronic device includes an input terminal, and the wireless charging device comprises an electric power transmitting module, an electric power receiving module, and an electric power transmission interface. The electric power receiving module can produce an electromagnetic effect with the electric power transmitting module, such that the electric power transmitting module outputs electric power to the electric power receiving module. The electric power transmission interface is electrically coupled to the electric power receiving module through a detachable electric power connecting module, and the electric power transmission interface can switch the electric power outputted from the electric power transmitting module to the electric power receiving module to charge the portable electronic device. The electric power transmission interface has an output connector detachably connectable to an input terminal of the portable electronic device.

### FIELD OF THE INVENTION

The present invention relates to a charging accessory of a portable electronic product, in particular to a wireless charging device applicable for various different specification or types of electronic products.

### BACKGROUND OF THE INVENTION

Portable electronic products such as mobile phones, digital cameras, flat PCs and notebook computers generally have the problem of requiring a portable and convenient power supply, so that wireless charging devices using the principle of electromagnetic induction for the charging are well developed.

In conventional wireless charging methods, a charging module of a wireless charger is generally used for charging a rechargeable battery installed in the electronic products directly through a conductive wire. In other words, the wireless charger can charge electronic products of a specification only, and the electronic products are generally bundled with a corresponding wireless charger before they shipped out from the factory. As a result, the products have a poor interchangeability of components or accessories, and users do not have too many choices.

In view of the foregoing problem, the inventor of the present invention conducts extensive researches and experiments, and finally provided a feasible design to overcome the problem.

### SUMMARY OF THE INVENTION

Therefore, it is a primary objective of the present invention to provide a wireless charging device that can be detachably coupled to a portable electronic device and a wireless charging device through an interface, and such arrangement not only improves the interchangeability of components or accessories of the product, but also provides more choices to users.

To achieve the aforementioned objective, the present invention provides a wireless charging device for coupling and charging a portable electronic device, and the portable electronic device comprises an input terminal, and the wireless charging device comprises: an electric power transmitting module, an electric power receiving module, and an electric power transmission interface. The electric power receiving module can produce an electromagnetic effect with the electric power transmitting module, such that the electric power transmitting module outputs electric power to the electric power receiving module. The electric power transmission interface is electrically coupled to the electric power receiving module through a detachable electric power connecting module, and the electric power transmission interface can switch the electric power outputted from the electric power transmitting module to the electric power receiving module in order to charge the portable electronic device. Wherein, the electric power transmission interface has an output connector detachably connectable to an input terminal of the portable electronic device. Therefore, the electric power transmission interface can be detachably coupled to the portable electronic device to achieve the foregoing objectives.

### BRIEF DESCRIPTION OF THE DRAWINGS

FIG. 1 is an exploded view of a wireless charging device of the present invention;

FIG. 2 is a schematic view of assembling a wireless charging device of the present invention with a portable electronic device;

FIG. 3 is a cross-sectional view of assembling a wireless charging device of the present invention with a portable electronic device; and

FIG. 4 is a perspective view of a wireless charging device of the present invention assembled with a portable electronic device.

### DESCRIPTION OF THE PREFERRED EMBODIMENTS

The technical characteristics and contents of the present invention will become apparent with the following detailed description and related drawings. The drawings are provided for the purpose of illustrating the present invention only, but not intended for limiting the scope of the invention.

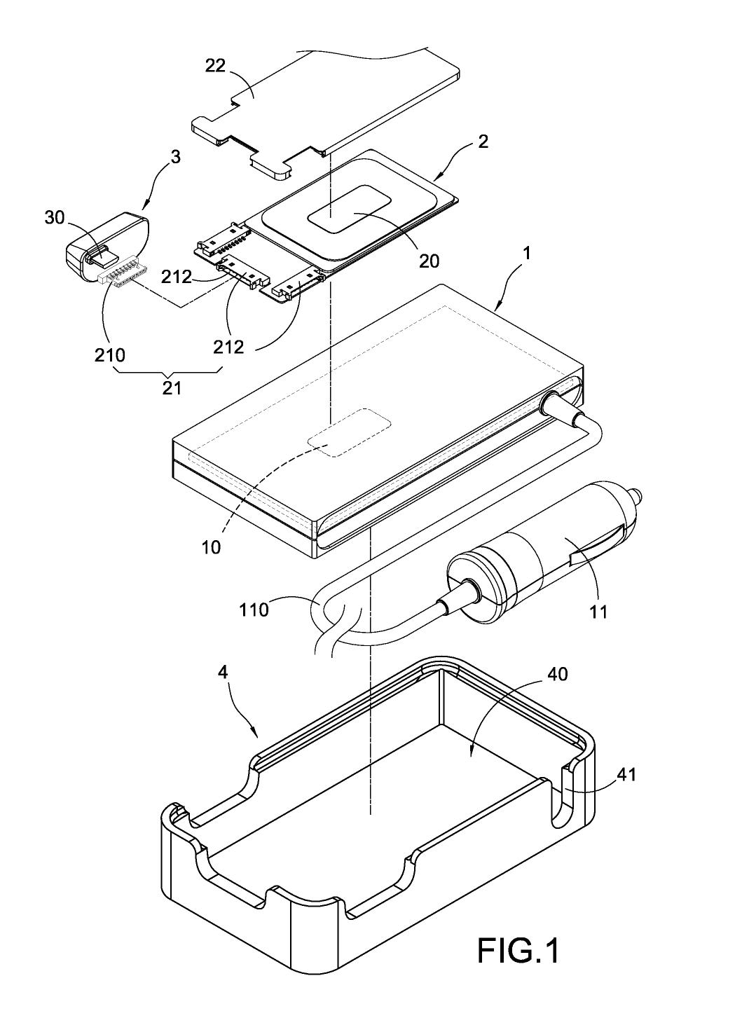

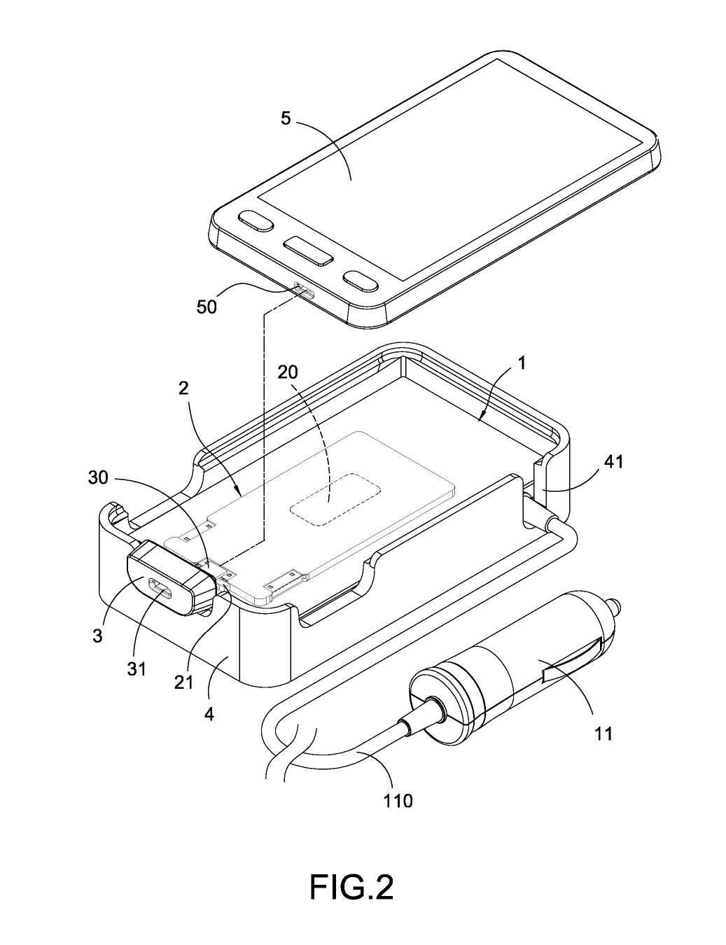

With reference to FIGS. 1 and 2 for an exploded view of the invention, and a schematic view of assembling a wireless charging device of the invention with a portable electronic device respectively, the wireless charging device is provided for charging the portable electronic device 5 after the portable electronic device 5 is connected. The wireless charging device comprises an electric power transmitting module 1, an electric power receiving module 2, and an electric power transmission interface 3.

The electric power transmitting module 1 is provided for generating electric power, and an electromagnetic effect can activate the electric power receiving module 2 to generate electric power. The electric power transmitting module 1 has a transmitting unit 10 coupled to an external power supply (such as utility power or automobile power supply) through a plug 11, and the plug 11 is further electrically coupled to the electric power transmitting module 1 through an electric wire 110.

The electric power receiving module 2 is corresponsive to the electric power transmitting module 1 and has a sensing unit 20 capable of producing an electromagnetic induction with the transmitting unit 10 of the electric power transmitting module 1, so that the electric power of the electric power transmitting module 1 can be outputted to the electric power receiving module 2 via a wireless transmission. The sensing unit 20 can be comprised of an induction circuit or a solenoid.

The electric power transmission interface 3 is electrically coupled to the electric power receiving module 2 for switching the electric power outputted to the electric power receiving module 2 to the portable electronic device 5 in order to charge the portable electronic device 5. The present invention is characterized in that the electric power transmission interface 3 is electrically coupled to the electric power receiving module 2 by a detachable electric power connecting module 21, and the detachable electric power connecting module 21 comprises a male plug 210 and one or more female sockets 211, and an upper lid 22 provided for protection, wherein the female socket 211 has a slot 212 formed therein and provided for plugging the male plug 210 to achieve an electric connection. In the meantime, the structure for plugging or unplugging the male plug 210 with the female socket 211 can be used to achieve the effect of improving the interchangeability of the components or accessories of the product. It is noteworthy to point out that the male plug 210 is disposed on the electric power transmission interface 3 and the female socket 211 is disposed on the electric power receiving module 2 in this preferred embodiment, but the positions (not shown in the figure) of the male plug 210 and the female socket 211 can be switched to achieve the same effect of detachably coupling the electric power transmission interface 3 with the electric power receiving module 2 for transmitting electric power. The female socket 211 comes with a plural quantity, and each female socket 211 is installed separately on three adjacent sides of an end of the electric power receiving module 2, so that the electric power receiving power module 2 can be applied to different types of portable electronic devise 5. If an input terminal 50 of the electronic device 5 is designed on any side, the input terminal 50 can be aligned with one of the upper and lower female sockets 211 to achieve the effect of inserting and connecting the electric power transmission interface 3 and the male plug 210.

In addition, the wireless charging device further comprises a frame base 4 for containing the electric power transmitting module 1 and the electric power receiving module 2 to facilitate the electric power transmitting module 1 and the electric power receiving module 2 to stack with each other to produce the electromagnetic induction. The frame base 4 has a hollow containing space 40 for stacking and containing the electric power transmitting module 1 and the electric power receiving module 2, and the frame base 4 has a notch 41 formed on a sidewall of the frame base 4 and provided for passing an electric wire 110 of the electric power transmitting module 1 through the notch 41 and extending the electric wire 110 outward, so that the plug 11 can be coupled to the external power supply.

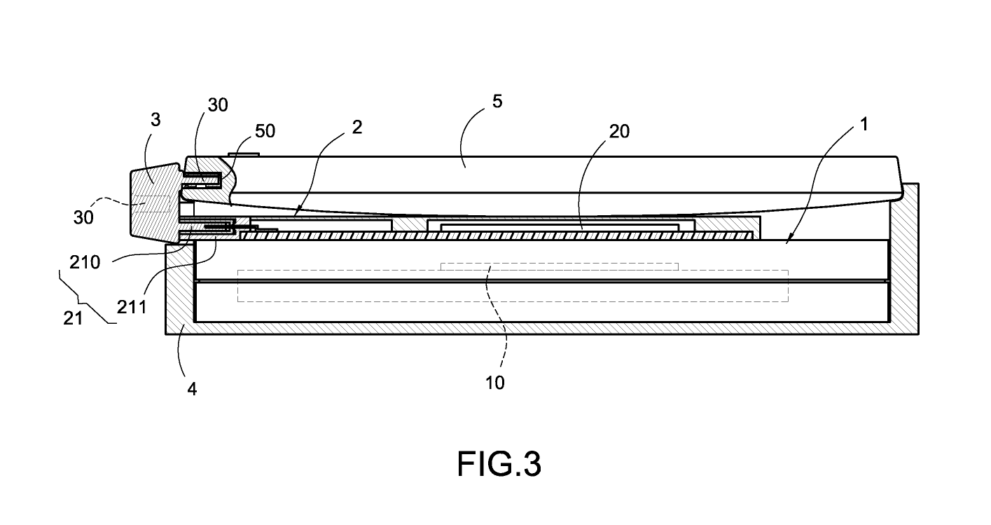

The wireless charging device of the present invention is produced in accordance with the aforementioned structure. In FIG. 3, if a user wants to charge the portable electronic device 5, the user simply connects the electric power transmission interface 3 with the portable electronic device 5, wherein the electric power transmission interface 3 has an output connector 30, and the output connector 30 can be detachably coupled to an input terminal 50 of the portable electronic device 5. In this preferred embodiment, the input terminal 50 of the portable electronic device 5 is a slot, so that the output connector 30 can be a male plug to be plugged into the input terminal 50 in order to charge the portable electronic device 5. In addition, the output connector 30 can be unplugged when the portable electronic device 5 is fully charged or no longer requires any charge.

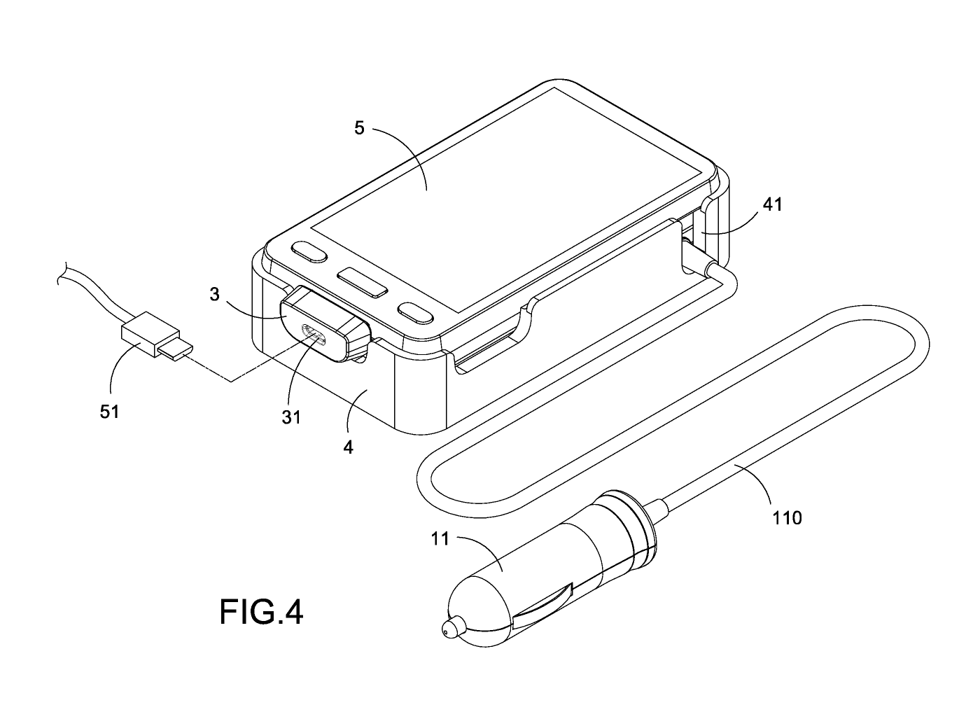

In FIG. 4, an external input terminal 31 is installed on the electric power transmission interface 3 to facilitate users to use the input terminal 50 without affecting the process of charging the portable electronic device 5. The external input terminal 31 and the output connector 30 can perform electronic transmissions with each other. When a transmission cable 51 is plugged into the external input terminal 31, the portable electronic device 5 and an external device (such as a computer) can transmit data with each other. The external input terminal 31 of this preferred embodiment is a slot having the same specification of the input terminal 50.

In summation of the description above, the present invention can achieve the expected objectives, overcomes the shortcomings of the prior art, and complies with the patent application requirements, and is thus duly filed for patent application. While the invention has been described by means of specific embodiments, numerous modifications and variations could be made thereto by those skilled in the art without departing from the scope and spirit of the invention set forth in the claims.

What is claimed is:

1. A wireless charging device, provided for coupling and charging a portable electronic device, and the portable electronic device comprising an input terminal; and the wireless charging device comprising:
an electric power transmitting module;
an electric power receiving module, capable of producing an electromagnetic effect with the electric power transmitting module, such that the electric power transmitting module outputs electric power to the electric power receiving module; and
an electric power transmission interface, electrically coupled to the electric power receiving module through a detachable electric power connecting module, and the electric power transmission interface being capable of switching the electric power outputted from the electric power transmitting module to the electric power receiving module to charge the portable electronic device;
wherein, the electric power transmission interface has an output connector detachably connectable to an input terminal of the portable electronic device.

2. The wireless charging device of claim 1, wherein the electric power transmitting module has a transmitting unit, and the electric power receiving module has a sensing unit corresponding to the transmitting unit for producing an electromagnetic induction.

3. The wireless charging device of claim 1, wherein the sensing unit is comprised of an induction circuit or a solenoid.

4. The wireless charging device of claim 1, wherein the electric power transmitting module is coupled to an external power supply through a plug.

5. The wireless charging device of claim 4, wherein the plug is electrically coupled to the electric power transmitting module through an electric wire.

6. The wireless charging device of claim 1, wherein the electric power transmission interface further includes an external input terminal, and the external input terminal and the output connector can perform an electronic transmission with one another.

7. The wireless charging device of claim 1, wherein the electric power connecting module includes a male plug and a female socket, and the female socket has a slot formed therein, and the male plug is plugged into and electrically coupled to the slot.

8. The wireless charging device of claim 7, wherein the male plug is disposed at the electric power transmission interface and the female socket is disposed at the electric power receiving module.

9. The wireless charging device of claim 7, wherein the female socket comes with a plural quantity and is installed separately on three adjacent sides at an end of the electric power receiving module.

10. The wireless charging device of claim 7, wherein the electric power receiving module further comprises an upper lid installed thereon.

11. The wireless charging device of claim 1, further comprising a frame base for containing the electric power transmitting module and the electric power receiving module.

12. The wireless charging device of claim 11, wherein the frame base has a hollow containing space formed therein and provided for containing the electric power transmitting module and the electric power receiving module.
